(19) United States
(12) Patent Application Publication
(10) Pub. No.: US 2025/0054039 A1
(43) Pub. Date: Feb. 13, 2025

(54) COMPONENT CONNECT FACILITY FOR TESTING CONNECTION OF A CONNECTOR TO A PRODUCT

(71) Applicant: INTERNATIONAL BUSINESS MACHINES CORPORATION, Armonk, NY (US)

(72) Inventors: Melanie DAUBER, Oceanside, NY (US); Zachary A. SILVERSTEIN, Georgetown, TX (US); Logan BAILEY, Atlanta, GA (US); Jacob Ryan JEPPERSON, St. Paul, MN (US); Jeremy R. FOX, Georgetown, TX (US)

(21) Appl. No.: 18/448,210

(22) Filed: Aug. 11, 2023

(51) Int. Cl. G06Q 30/0601

(52) U.S. Cl. CPC G06Q 30/0627

(57) ABSTRACT

A component connect facility is provided which generates a list of components which can operatively connect to a product, and obtains an identification of a selected component in the list of components. The selected component connects to the product via an associated connector. The facility further initiates creating a dummy connector replicating, at least in part, the associated connector, where the dummy connector facilitates test connecting to the product.

### BACKGROUND

This disclosure relates generally to enhanced computing environment processing, and more particularly, to enhanced processing to facilitate a transaction, such as an eCommerce transaction.

For many years, commerce has been divided into online and offline experiences. Many consumers now engage in a hybrid approach, where a single shopping experience can involve both in-store and digital touch points. For instance, a consumer might locate a product of interest by visiting a website of a retailer directly, or by searching among alternative vendors using a shopping search engine. A user can compare and evaluate products using product information on the website, as well as other websites, such as websites about product tests and reviews, and then go to a store to obtain the product or component.

### SUMMARY

Certain shortcomings of the prior art are overcome, and additional advantages are provided herein through the provision of a computer-implemented method which includes generating a list of components which can operatively connect to a product, and obtaining identification of a selected component in the list of components, where the selected component connects to the product via an associated connector. Further, the computer-implemented method includes initiating creating a dummy connector replicating, at least in part, the associated connector, where the dummy connector facilitates test connecting to the product.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIG. 2 depicts one embodiment of a computer program product with a component connect facility module, in accordance with one or more aspects of the present disclosure;

FIG. 3 depicts one embodiment of a component connect facility process, in accordance with one or more aspects of the present disclosure;

FIG. 4 depicts another embodiment of a component connect facility workflow, in accordance with one or more aspects of the present disclosure; and

FIG. 5 is a further example of a computing environment to include and/or use one or more aspects of the present disclosure.

### DETAILED DESCRIPTION

The accompanying figures, which are incorporated in and form a part of this specification, further illustrate the present disclosure and, together with this detailed description of the disclosure, serve to explain aspects of the present disclosure. Note in this regard that descriptions of well-known systems, devices, processing techniques, etc., are omitted so as to not unnecessarily obscure the disclosure in detail. It should be understood, however, that the detailed description and this specific example(s), while indicating aspects of the disclosure, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, etc. One or more aspects of an illustrative control embodiment can be implemented in software, hardware, or a combination thereof.

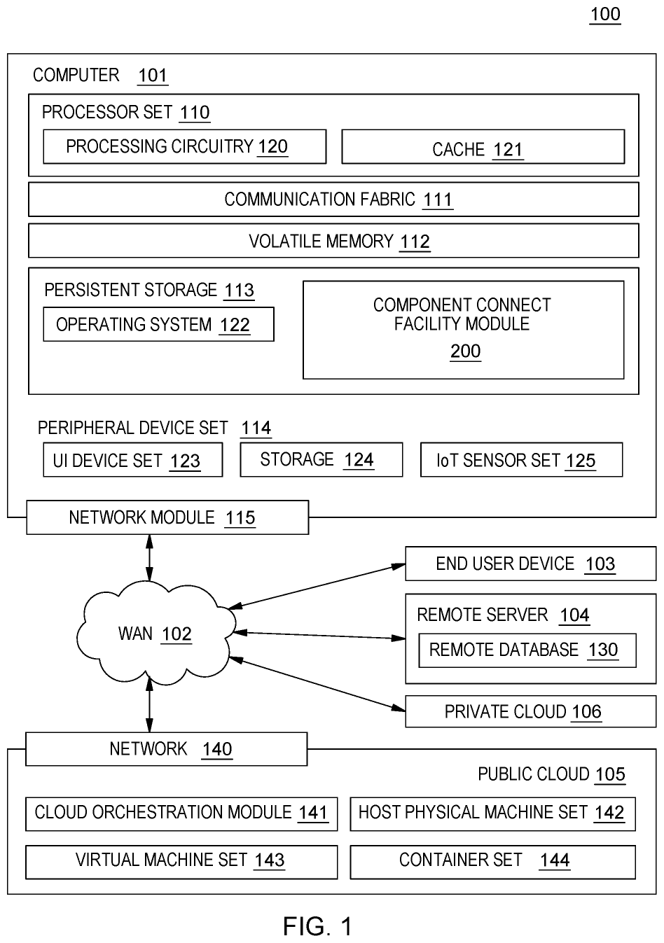

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as one or more programs, are depicted in FIG. 1, including operating system 122 and component connect facility module 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform component connect facility processing, such as disclosed herein. Aspects of the present disclosure are not limited to a particular architecture or environment.

Prior to further describing detailed embodiments of the present disclosure, an example of a computing environment to include and/or use one or more aspects of the present disclosure is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as component connect facility module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

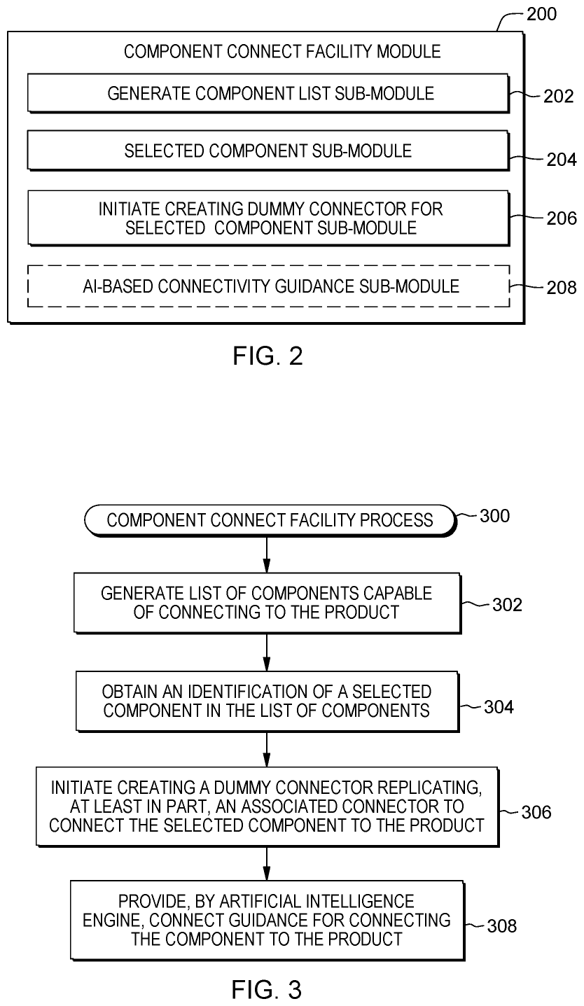

By way of example, one or more embodiments of a component connect facility module and process are described initially with reference to FIGS. 2-3. FIG. 2 depicts one embodiment of component connect facility module 200 that includes code or instructions to perform component connect facility processing, in accordance with one or more aspects of the present disclosure, and FIG. 3 depicts one embodiment of a component connect facility process, in accordance with one or more aspects of the present disclosure.

Referring to FIGS. 1-2, component connect facility module 200 includes, in one example, various sub-modules used to perform processing, in accordance with one or more aspects of the present disclosure. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

As noted, FIG. 2 depicts one embodiment of a component connect facility module 200 which, in one or more embodiments, includes, or provides, a generate component list sub-module 202 to generate a list of components which can operatively connect to a product, such as a user-owned product. Note that “component” is used herein broadly to mean any product, article, attachment, object, device, etc., which can operatively connect to the product (e.g., an existing product) via an associated connector.

In addition, component connect facility module 200 includes a selected component sub-module 204 to obtain an identification of a selected component in the list of components, where the selected component connects to the product via an associated connector. Note that “connector” is used herein as including, for instance, a mechanical connector, electrical connector, electromechanical connector, or other type of connector designed to operatively connect or couple the selected component to the product. In one embodiment, the product is a first product and the component is a second product, where the first and second products can be operatively connected together by one or more connectors configured to operatively connect the first and second products. By way of example only, the first product can be a first electronic device or system, and the second product can be a second electronic device or system.

In addition, in the embodiment of FIG. 2, component connect facility module 200 further includes an initiate creating dummy connector for selected component sub-module 206 to initiate creating a dummy connector replicating, at least in part, the associated connector, where the dummy connector facilitates test connecting to the product. In one or more embodiments, component connect facility module 200 optionally includes an artificial-intelligence-based (AI-based) connect guidance sub-module 208 to provide connect guidance to a user for connecting, for instance, the component to the product using the connector, and/or for test connecting the dummy connector to the product.

Advantageously, a component connect facility such as disclosed herein facilitates, in one or more embodiments, computing environment processing, and more particularly, facilitates processing (and completion) of a transaction, such as an eCommerce transaction. In one or more embodiments, a dummy connector (specific to an associated connector of a product and/or selected component to connect to the product) is created replicating, at least in part, the associated connector to facilitate test connecting the dummy connector to the product, for instance, to verify selection of an appropriate component and/or an appropriate connector for the product. Note that although various sub-modules are described, component connect facility module processing such as disclosed herein can use, or include, additional, fewer, and/or different sub-modules. A particular sub-module can include additional code, including code of other sub-modules, or less code. Further, additional and/or other sub-modules can be used. Many variations are possible.

In one or more embodiments, the sub-modules are used, in accordance with one or more aspects of the present disclosure, to perform component connect facility processing. FIG. 3 depicts one example of a component connect facility process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as component connect facility module 200. In other examples, the code can be included in one or more other modules and/or in one or more sub-modules of the one or more other modules. Various options are available.

As one example, component connect facility process 300 executing on a computer (e.g., computer 101 of FIG. 1), a processor (e.g., a processor of processor set 110 of FIG. 1), and/or processing circuitry (e.g., processing circuitry of processor set 110), generates a list of components which can operatively connect to a product 302. For instance, in one or more embodiments, the product is a user-owned product, and generating the list of components includes generating the list of components from a generic knowledge corpus containing data on one or more components that are operatively connectable to one or more different products. In one or more embodiments, the list of components can be a list of manufacturer-specific components, vendor-specific components, etc.

In one or more embodiments, the component connect facility process 300 further includes obtaining identification of a selected component in the list of components 304. In one or more embodiments, the selected component can be selected or identified by a user, such as a registered user of the component connect facility.

In one or more embodiments, component connect facility process 300 also includes initiating creating a dummy connector replicating, at least in part, the associated connector to facilitate test connecting the dummy connector to the product. For instance, in one embodiment, the creating can include 3-D printing the dummy connector replicating, at least in part, the associated connector to facilitate test connecting the dummy connector to the product. In one or more embodiments, initiating creating the dummy connector can include obtaining or providing a stereolithography file containing a 3-D model for 3-D printing the dummy connector replicating, at least in part, the associated connector. Note that the dummy connector being created (for instance, 3-D printed) can, in one or more embodiments, be configured mechanically similar or identical to the connector to connect the selected component to the product, while lacking one or more features or attributes of the connector. For instance, the dummy connector can be 3-D printed from a different material than the material(s) from which the connector is manufactured, and/or the dummy connector can contain one or more fewer features than the connector. For instance, in the case of an electromechanical connector, the dummy connector can mirror the mechanical properties of the electromechanical connector, but not the electrical properties (in one example). Many other dummy connector variations are possible. Pursuant to this disclosure, the dummy connector is created to facilitate, for instance, testing mating of the dummy connector to the product, and hence, to understand better whether the component and associated connector will operatively connect to the product. In addition, the connector and/or dummy connector can be used in association with artificial-intelligence-generated instructions to facilitate teaching a user how to connect the connector to the product.

In one or more embodiments, component connect facility process 300 further includes providing, by an artificial intelligence engine, connect guidance for connecting the component to the product using the connector 308. For instance, the connect guidance provided by the artificial intelligence engine can include one or more of text-based guidance, audio-based guidance, and/or simulated reality guidance (e.g., augmented reality (AR) guidance and/or virtual reality (VR) guidance) for connecting the component to the product using the connector. In one or more embodiments, the artificial intelligence engine provides the connect guidance either in association with creating the dummy connector replicating, at least in part, the associated connector, and/or with delivery of the component and the associated connector to a user, where the user will be connecting the component to the product using the connector.

By way of example, an individual may wish to purchase a component (i.e., a product) online that interfaces with a user-owned product by way of an associated connector. For instance, the user may own a printer with a graphics card to be replaced, or a specific lamp requiring a particular type of lightbulb base. The process of installing the new component in the user-owned product can be challenging, particular when there is a risk of damaging the new component. The component connect facility disclosed herein, by creating a dummy connector replicating, at least in part, the associated connector, facilitates test connecting the dummy connector for the component to the product. Considering the complexity of many products and/or components, it is advantageous to provide a more comprehensive solution to demonstrating how a selected component with an associated connector will integrate with a user's existing product. To facilitate this, the dummy connector can be created (in one embodiment) using a 3-D printer to practice/demonstrate test connecting of the dummy connector to the existing product. In this manner, a user is better able to make a decision regarding a selected component and associated connector, and thereby facilitate the online transaction. Advantageously, the component connect facility disclosed herein allows, for instance, a user of an existing product to understand how a new component, such as a next generation component or product, can add onto the existing product, and in particular, how that component can integrate or operatively connect into the existing product, using the dummy connector to test or demonstrate connecting of the component to the product.

Generally stated, disclosed herein are computer-implemented methods, computer systems, and computer program products which implement, or include, a component connect facility, such as disclosed herein. For instance, the computer-implemented methods include generating a list of components which can operatively connect to a product. In one or more embodiments, the product is a user-owned product, and generating the list of components includes generating the list of components from a generic knowledge corpus containing data on one or more components that are operatively connectable to one or more different products, where the user-owned product is one product of the one or more products. In one embodiment, generating the list of components further incudes generating the list of components based, at least in part, on user product-related data. Note in this regard that, in one or more embodiments, the user can register or opt-in to use of a component connect facility such as disclosed herein.

In addition, the computer-implemented method includes obtaining identification (such as a user identification) of a selected component in the list of components, where the selected components connect to the product via an associated connector. In one embodiment, the product can be an existing, user-owned product.

The computer-implemented method further includes initiating creating a dummy connector replicating, at least in part, the associated connector, where the dummy connector facilitates test connecting to the product, and thereby indirect test connecting the associated connector of the selected component to the product. In one or more embodiments, creating the dummy connector includes 3-D printing the dummy connector replicating, at least in part, the associated connector. In one embodiment, the computer-implemented method further includes providing a stereolithography file for 3-D printing the dummy connector. For instance, in one embodiment, the user has a 3-D printer, and the component connect facility forwards the stereolithography file to the user's 3-D printer for printing the dummy connector. In one or more other embodiments, the 3-D printer resides at, for instance, a manufacturer or a logistics entity (or vendor), which can print the dummy connector to facilitate the test connecting of the dummy connector to the product. In one embodiment, the product is owned by a user, and creating the dummy connector replicating, at least in part, the associated connector facilitates testing connecting the dummy connector for the component to the product.

In one or more embodiments, the computer-implemented method further includes providing, by an artificial intelligence engine, connect guidance for connecting the component to the product using the connector. In one embodiment, the connect guidance provided by the artificial intelligence engine includes simulated reality connect guidance for connecting the component to the product using the connector. For instance, in one or more embodiments, the simulated reality connect guidance can include augmented reality (AR) guidance and/or virtual reality (VR) guidance delivered to the user via, for instance, augmented reality glasses and/or a virtual reality headset, by way of example only. In one or more embodiments, the computer-implemented method alternatively, and/or further includes, providing, by the artificial intelligence engine, connect guidance for test connecting the dummy connector to the product. For instance, the connect guidance can be provided to a user of a product (e.g., an electronic device or system) for test connecting the dummy connector to the product.

In another example, a computer-implemented method is disclosed herein which includes creating a generic knowledge corpus for one or more manufacturers which contains information or data about one or more components and the components' associated connectors, where the components are available to connect to one or more different products, and the associated connectors connect one or more of the components to the one or more different products. Responsive to a user purchasing or already owning a product from a particular manufacturer, the component connect facility can generate a list of components which can operatively connect to that product, where the list can be generated, at least in part, from the generic knowledge corpus. Responsive to the user selecting a particular component from the list of components, the component connect facilitate initiates creating a dummy connector replicating, at least in part, the associated connector to facilitate test connecting the dummy connector to the product. In one embodiment, the component and connector, as well as the dummy connector, are tailored to a particular use case associated with the user and/or a user-owned product. The dummy connector can be provided either ahead of time to the user for test connecting to the product, and thereby facilitate identifying or confirming selection of the appropriate component and associated connector, and/or can be provided along with the component and/or product to, for instance, facilitate instructing the user how to connect the component and connector to the product (through use of the dummy connector). In one or more embodiments, the dummy connector can connect to the product without presence of the associated component.

Advantageously, provided herein are computer-implemented methods, computer systems and computer program products which provide, for instance, a user and component-specific dummy connector (e.g., 3-D printed connector) to demonstrate connectivity of an associated component to a product, such as a user-owned product. In one or more implementations, the dummy connector can be provided separately from the component to be operatively connected to the product, or along with the component, to assist in user-familiarity with connecting the component to the product. In one embodiment, the component connect facility disclosed herein allows a user to, for instance, during the process of making a purchase, to select a component and have the component connect facility generate a dummy connector for connecting that component to the desired product, such as a user-owned product. In one or more embodiments, the component connect facility can identify segments or pieces of a component connector that may require manual and/or external manipulation, and generate a 3-D print model for 3D-printing the dummy connector with those segments or pieces for user reference. For instance, where a user wishes to install a non-factory or after-market part, but is concerned about manipulating the part incorrectly and causing damage during installation, the component connect facility can create a dummy connector replicating, at least in part, the connector associated with the selected component to facilitate the user test connecting the dummy connector to the product, and thereby gain tactile familiarity with making the connection. In one or more further embodiments, the component connect facility includes an artificial intelligence engine which can, for instance, facilitate generation of the 3-D print model, and/or be configured to provide connect guidance for connecting the selected component to a product using the associated connector and/or the created dummy connector replicating, at least in part, the associated connector.

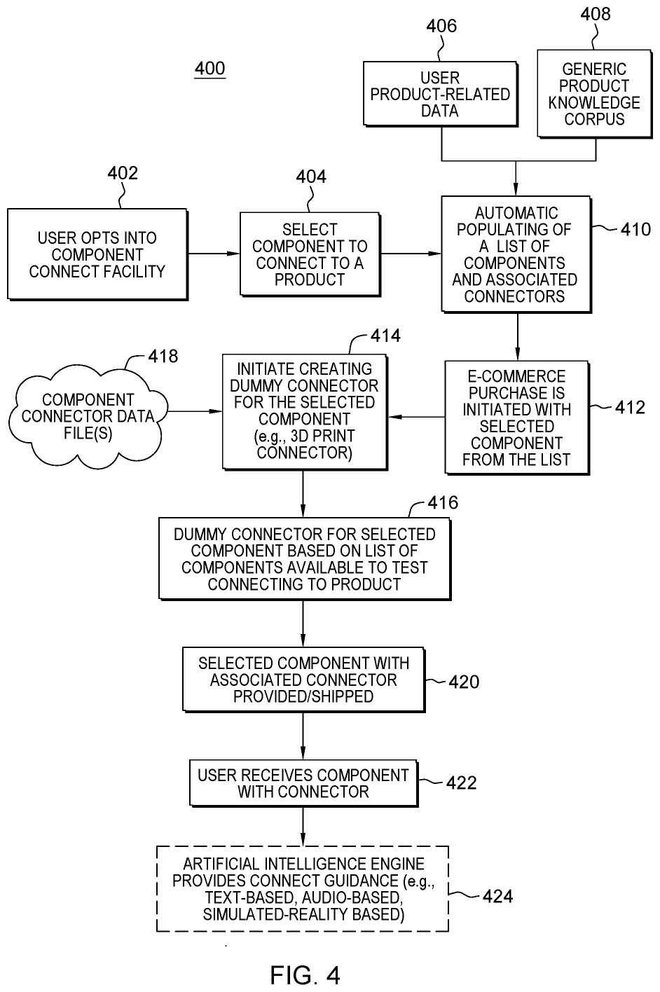

FIG. 4 depicts another embodiment of a component connect facility workflow 400, in accordance with one or more aspects of the present disclosure. In the embodiment of FIG. 4, the component connect facility workflow includes a user opt-in to the component connect facility process 402. For instance, the user can be presented with terms and conditions of usage of the component connect facility which are accepted before proceeding. In one embodiment, this can be done by clicking an “Accept” button, or clicking an agreement checkbox, yielding, for instance, a user opt-in completed indication. In one or more embodiments, as part of the opt-in or registration process, the user grants access to, for instance, the user's product-related data 406, which can be used (in one embodiment) to customize selection of one or more components and associated connectors. This product-related data can include information about one or more of the user's existing products, and any associated connectors, and other product or connector-relevant information.

Note that, to the extent implementation of this disclosure collect, store, or employ, personal information provided by, or obtained from, a user of the computer-implemented component connect facility (for example, products owned by the user), such information shall be used in accordance with all applicable laws concerning protection of personal information. Additionally, the collection, storage and use of such information can be subject to consent of the individual to such activity, for example, through “opt-in” or “opt-out” processes, as may be appropriate for the situation and type of information. Storage and use of personal information can be in any appropriately secure manner reflective of the type of information, for example, through various encryption and anonymization techniques for particularly sensitive information.

In one embodiment, the user browses or desires to purchase an enabled component, which can include the user selecting a component of interest to connect to a product 404, such as a user-owned product. For instance, the user can browse an online store to search for a particular component that is enabled with the component connect facility processing disclosed herein. In such a case, the component can be marked clearly, so that the user knows that the component is enabled with the component connect facility processing disclosed herein, such as by a marking or highlighting.

In one embodiment, the user selects the desired component from a list of components and associated connectors 410 that has been automatically populated by the component connect facility from, for instance, the user product-related data 406 and from a generic product knowledge corpus 408, which can include generic product knowledge about the user's existing product, and/or one or more components that are operatively connectable to the user's existing product.

As noted, the user product-related data 406 can include personalized knowledge data created for each individual user (i.e., each opt-in user or registered user), and can include information about the user's existing products, connectors required to connect to those products, and other relevant component, product and/or connector information. The user's existing products and associated connectors can be identified and stored in the user product-related data corpus. In one embodiment, this can include scanning the user's existing products for identifying information, and/or manually entering the data into the product-related data corpus.

By way of example, the generic knowledge corpus is built and maintained for a particular manufacturer's products, or for multiple manufacturers' products. The corpus can contain information about the associated connectors for the particular components and the different products. Information in the corpus can be automatically generated from various sources, such as online manufacturer specifications, industry standards, crowd-sourced feedback data, etc. The information or data can be used to generate, in one embodiment, the list of components and associated connectors when, for instance, a user is considering purchasing a particular component to operatively connect to a product, such as an existing product, or a to-be-purchased product.

In one embodiment, automatic populating of the list of components and associated connectors 410 can include the component connect facility accessing user product-related data 406 to identify the user's existing products and associated connectors, and the generic product knowledge corpus 408 to identify, for instance, components capable of being operatively connected to one or more user products, and the associated connectors for connecting the components to the products. In one embodiment, the component connect facility automatically populates the list of components and associated connectors 410 based on, for instance, a particular user-owned product for which a component is to be obtained. The list of components can be presented to the user, for instance, displayed on the user's electronic device or system to allow the user to select a particular component of interest from the list.

In one embodiment, a purchase (such as an eCommerce purchase) is initiated with the selected component from the list 412. As part of initiating the purchase, the component connect facility initiates creating a dummy connector for the selected component to connect to the product 414. For instance, the component connect facility can initiate 3-D printing of a dummy connector from one or more component connector data files 418, such as one or more stereolithography files for 3-D printing of different dummy connectors. In one example, creating the dummy connector can be at the manufacturer, the vendor or logistics entity, or at the user's location, depending on the implementation. In each case, the dummy connector is specific to the user's existing product and the selected component to operatively connect to the product. The dummy connector can be created using connector stereolithography (STL) and/or blueprint data identified by the facility for the connector, which ensures that the dummy connector is compatible with the user's existing product, and the desired component. For instance, in one embodiment, the dummy connector is printed to mirror the structure of the actual connector for the component, however, it is different in one or more aspects from the actual connector. For instance, where the actual connector is an a mechanical connector, the dummy connector can be structurally identical but, for instance, formed of a different material or, where the actual connector is, for instance, an electromechanical connector, the dummy connector can mirror the mechanical structure of the connector without (for instance) the electrical aspects of the connector. Many variations are possible. For instance, in one example, the component connector data file 418 contains data about size and shape of the connector, and how the connector connects to the product (i.e., the user-owned or user-chosen product, or the selected component). In one embodiment, the component connector data file contains information unique to the particular user-owned or user-selected product, as well as the selected component.

In one embodiment, the workflow further includes providing the dummy connector for the selected component to test connecting of the dummy connector to the product 416. As noted, the dummy connector can be provided separate from the selected component, or along with the selected component, if desired. In one or more embodiments, the component and associated connector can be integrated or preassembled by the manufacturer or vendor, and the dummy connector can be provided separate to allow the user to practice connecting the dummy connector to the product in order to make it easier for the user to then connect the component and associated connector to the product. In one embodiment, the selected component (with the associated connector) is provided or shipped to the user 420, and the user receives the component with the connector 422, for instance, after having practiced already with the dummy connector, or along with the dummy connector, to allow the user to practice connecting the connector to the product before connecting the component with the associated connector to the product. In this manner, the dummy connector allows the user to better understand how to connect the component to the existing user-owned product. In one embodiment, after using the dummy connector, the user can then install or connect the component with the associated connector onto, or into, the product.

As noted, in one or more embodiments, the component connect facility disclosed herein further includes an artificial intelligence engine to generate connect guidance for connecting a particular component to the product using the associated connector. The connect guidance can be generated from an instruction corpus available to, or generated by, the artificial intelligence engine. In one embodiment, the artificial intelligence engine generates instructions based on the user's existing product(s), such as a user-owned product, and/or based on the selected component and the associated connector. In one embodiment, the generated instructions are uniquely tailored to the specific user's situation, and are provided to guide that user through the installation process. In this manner, the artificial-intelligence-engine-generated connect guidance can be specific to the particular user, and the user's use case.

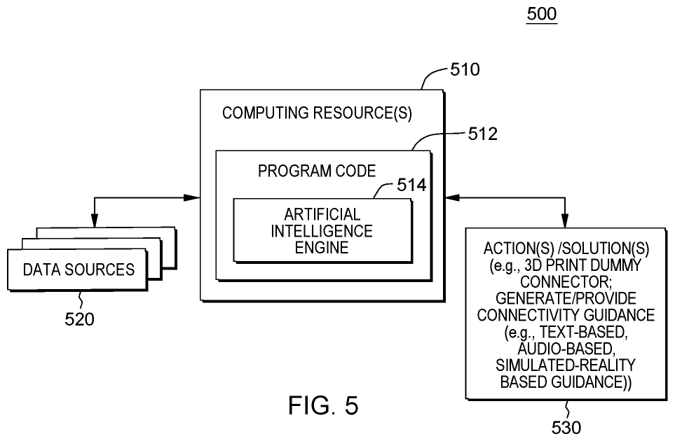

By way of further explanation, FIG. 5 depicts another embodiment of a computing environment or system 500, which can incorporate, or implement, one or more aspects of an embodiment of the present disclosure. In one or more implementations, system 500 is implemented as part of a computing environment, such as computing environment 100 described above in connection with FIG. 1. System 500 includes one or more computing resources 510 that execute program code 512 that implements, for instance, one or more aspects of a module or facility such as disclosed herein, and which includes an artificial-intelligence-based engine 514, which can utilize one or more machine learning models. Data, such as generic product knowledge corpus data, user product-related data, and/or other product-related data, component-related data (where a component is configured to operatively connect to a product via an associated connector), and/or other data associated with generating one or more machine learning models to be used in accordance with one or more aspects of the present disclosure, can be used by the artificial intelligence engine to train a machine learning model(s) to, for instance, facilitate identification and creation (e.g., 3-D printing) of a dummy connector to facilitate test connecting to a product, such as a user-owned product, and/or to provide or generate connect guidance, such as text-based guidance, audio-based guidance, simulated reality-based guidance, for connecting the selected component to the product using the connector 530 (in one embodiment). In one implementation, system 500 can include, or utilize, one or more networks for interfacing various aspects of computing resource(s) 510, as well as one or more data sources 520 providing data, and one or more components, systems, etc., receiving an output, action, etc., 530 of the artificial intelligence engine 514 to facilitate performance of one or more operations. By way of example, the network(s) can be, for instance, a telecommunications network, a local-area network (LAN), a wide-area network (WAN), such as the Internet, or a combination thereof, and can include wired, wireless, fiber-optic connections, etc., operatively coupling the computing resource(s) 601 to the floating solar array and to other data sources. The network(s) can include one or more wired and/or wireless networks that are capable of receiving and transmitting data, including training data for a machine-learning model, and an output solution, recommendation, action, of a machine-learning model(s), such as discussed herein.

In one or more implementations, computing resource(s) 510 house and/or execute program code 512 configured to perform methods in accordance with one or more aspects of the present disclosure. By way of example, computing resource(s) 510 can be a computing-system-implemented resource(s). Further, for illustrative purposes only, computing resource(s) 510 in FIG. 5 is depicted as being a single computing resource. This is a non-limiting example of an implementation. In one or more other implementations, computing resource(s) 510 can, at least in part, be multiple separate computing resources or systems, such as one or more computing resources of a cloud-hosting environment, by way of example only.

Briefly described, in one embodiment, computing resource(s) 510 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed are described further herein with reference to the figures.

In one embodiment, program code 512 executes artificial intelligence engine 514, which can include (and optionally train) one or more models. The models can be trained using training data that can include a variety of types of data, depending on the model and the data sources. In one or more embodiments, program code 512 executing on one or more computing resources 510 applies one or more algorithms of artificial intelligence engine 514 to generate and train the model(s), which the program code then utilizes, for instance, to facilitate identification and 3-D printing of a dummy connector to facilitate test connecting of the connector to a product, such as a user-owned product, and/or to provide or generate connect guidance, such as text-based guidance, audio-based guidance, simulated reality-based guidance, for connecting the component to the product using the connector 530. In an initialization or learning stage, program code 512 can train one or more machine learning models using obtained training data that can include, in one or more embodiments, one or more data source inputs, including a generic product knowledge corpus, user product-related data, and/or other product-related data, and/or component-related data (where a component is configured to operatively connect to a product via an associated connector), such as described herein.

Data used to train the models, in one or more embodiments of the present disclosure, can include a variety of types of data, such as heterogeneous data generated by multiple data sources and/or data stored in one or more databases accessible by, the computing resource(s). Program code, in embodiments of the present disclosure, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h (x), also referred to as a hypothesis, which the program code utilizes as a model. In identifying machine learning model(s), various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present disclosure, the program code can utilize one or more neural networks to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identify patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine-learning model, such as described herein.

In one or more embodiments, the artificial intelligence engine 514 can be configured to provide recommendations for standardizing, for instance, existing, new, and/or future product or component purchases to a common conformance standard. Over time, the recommendations can make it more cost and material effective to upgrade existing and new products to common standards, rather than to continue to purchase independent components or parts that require specific associated connectors or connection apparatuses.

The terminology used herein is for the purpose of describing particular embodiments only and is not intended to be limiting of the disclosure. As used herein, the singular forms “a”, “and” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
generating a list of components which can operatively connect to a product;
obtaining identification of a selected component in the list of components, the selected component connecting to the product via an associated connector; and
initiating creating a dummy connector replicating, at least in part, the associated connector, the dummy connector facilitating test connecting to the product.

2. The computer-implemented method of claim 1, wherein the creating comprises 3-D printing the dummy connector replicating, at least in part, the associated connector to facilitate test connecting the dummy connector to the product.

3. The computer-implemented method of claim 2, further comprising providing a stereolithography file for 3-D printing the dummy connector replicating, at least in part, the associated connector.

4. The computer-implemented method of claim 2, wherein the product is owned by a user, and creating the dummy connector replicating, at least in part, the associated connector facilitates the user test connecting the dummy connector to the product.

5. The computer-implemented method of claim 1, wherein the product is a user-owned product, and generating the list of components includes generating the list of components from a generic knowledge corpus containing data on one or more components that are operatively connectable to one or more different products, the user-owned product being one product of the one or more products.

6. The computer-implemented method of claim 5, wherein generating the list of components further comprises generating the list of components based, at least in part, on user product-related data.

7. The computer-implemented method of claim 1, further comprising providing, by an artificial intelligence engine, connect guidance for connecting the component to the product using the connector.

8. The computer-implemented method of claim 7, wherein the connect guidance provided by the artificial intelligence engine comprises simulated reality connect guidance for connecting the component to the product using the connector.

9. The computer-implemented method of claim 1, further comprising providing, by an artificial intelligence engine, connect guidance for test connecting the dummy connector to the product.

10. A computer system comprising:
a memory; and
at least one processor in communication with the memory, wherein the computer system is configured to perform a method, the method comprising:
generating a list of components which can operatively connect to a product;
obtaining identification of a selected component in the list of components, the selected component connecting to the product via an associated connector; and
initiating creating a dummy connector replicating, at least in part, the associated connector, the dummy connector facilitating test connecting to the product.

11. The computer system of claim 10, wherein the creating comprises 3-D printing the dummy connector replicating, at least in part, the associated connector to facilitate test connecting the dummy connector to the product.

12. The computer system of claim 11, wherein the product is owned by a user, and creating the dummy connector replicating, at least in part, the associated connector facilitates the user test connecting the dummy connector to the product.

13. The computer system of claim 10, wherein the product is a user-owned product, and generating the list of components includes generating the list of components from a generic knowledge corpus containing data on one or more components that are operatively connectable to one or more different products, the user-owned product being one product of the one or more products.

14. The computer system of claim 13, wherein generating the list of components further comprises generating the list of components based, at least in part, on user product-related data.

15. The computer system of claim 10, further comprising providing, by an artificial intelligence engine, connect guidance for connecting the component to the product using the connector.

16. A computer program product comprising:
one or more computer readable storage media and program instructions collectively stored on the one or more computer readable storage media readable by at least one processer to:
generate a list of components which can operatively connect to a product;
obtain identification of a selected component in the list of components, the selected component connecting to the product via an associated connector; and
initiate creating a dummy connector replicating, at least in part, the associated connector, the dummy connector facilitating test connecting to the product.

17. The computer program product of claim 16, wherein the creating comprises 3-D printing the dummy connector replicating, at least in part, the associated connector to facilitate test connecting the dummy connector to the product.

18. The computer program product of claim 16, wherein the product is a user-owned product, and generating the list of components includes generating the list of components from a generic knowledge corpus containing data on one or more components that are operatively connectable to one or more different products, the user-owned product being one product of the one or more products.

19. The computer program product of claim 18, wherein generating the list of components further comprises generating the list of components based, at least in part, on user product-related data.

20. The computer program product of claim 16, further comprising providing, by an artificial intelligence engine, connect guidance for connecting the component to the product using the connector.
